(19) United States
(12) Patent Application Publication
(10) Pub. No.: US 2022/0410607 A1
(43) Pub. Date: Dec. 29, 2022

(54) 3D ANTI-COUNTERFEITING PATTERN AND PROCESSING OF THE SAME

(71) Applicants: University of Maryland, College Park, College Park, MD (US); Anhui University of Technology, Ma'anshan (CN)

(72) Inventors: Po-Yen CHEN, Cambridge, MA (US); Qian XIE, Ma'anshan (CN)

(21) Appl. No.: 17/850,218

(22) Filed: Jun. 27, 2022

Related U.S. Application Data
(60) Provisional application No. 63/216,390, filed on Jun. 29, 2021.

(51) Int. Cl. B41M 3/14; B41M 3/00

(52) U.S. Cl. CPC B41M 3/14; B41M 3/003

(57) ABSTRACT

A 3D physical unclonable functions (PUF) system produced based on harnessing the out-of-plane crumpling of a layer of 2D material during shrinkage of a substrate carrying such layer. The structural details of the so-formed 3D PUF pattern are extracted from the tags in a layer-by-layer fashion using confocal laser microscopy imaging and then reconstructed to form the 3D PUF keys and stored in the database, serving as a secure anti-counterfeiting PUF that demonstrates encoding capacity in excess of 10^{40,000,000}. Authentication is performed with a customized trained Siamese neural network framework in a matter of few minutes in a fashion that does not depend on rotation, linear translation, tilt, variations of contrast and/or resolution of the extracted optical images.

### CROSS-REFERENCE TO RELATED APPLICATIONS

This patent application claims priority from, and benefit of the U.S. Provisional Patent Application No. 63/216,390 filed on Jun. 29, 2021, the disclosure of which is incorporated herein by reference.

### TECHNICAL FIELD

The disclosed subject matter generally relates to the generation and use of a physical unclonable function, or PUF tag—or PUF, for short—with rich structure information and, in particular, a 3D PUF created on the basis of and by modifying a layer of a two-dimensional material and—while maintaining a substantially single material layer structure—possessing the encoding capacity exceeding that of a conventional 2D PUF at least by a coefficient of 10^{40,000,000}.

### RELATED ART

Physical unclonable functions (PUFs), possessing unique physical manifestations with sufficient complexity, are the cornerstone of highly secure, anti-counterfeiting technologies. The term physical unclonable function (or, PUF, interchangeably referred to as PUF system, or PUF anti-counterfeiting system) is used to refer to and defined as a physical object that for a given input and conditions (challenge), provides a physically defined “digital fingerprint” output (response)—the latter serving as a unique identifier for substantially any target object (for example, as an identifier of authenticity for a device from a set of numerous devices offered for sale). A PUF is a physical entity embodied in a physical structure with inherent, distinct, and fingerprint-like features ensuring its uniqueness and, for that reason, security of identification, which makes the PUFs difficult to repeat and/or reproduce. As a skilled person readily recognizes, a unique identifier (or, UID) is an identifier that is guaranteed to be unique among all identifiers used for those objects and for a specific purpose.

While, in theory, unique PUF patterns can be generated in a stochastic and non-deterministic fashion and can provide huge encoding capacity (i.e., the theoretical maximum number of distinct PUF patterns), to date most of the PUF anti-counterfeiting systems based on visual patterns are in two-dimension (2D), such as biometric fingerprints, fluorescence security labels, and physically responsive patterns (e. g., those sensitive to light, heat, humidity, etc.).⁷ Besides the physical instability issues of the existing PUFs (see, for example, Y. Liu, et al., in Nat. Commun., 2019, 10, 2409; or B. Duong et al., ACS Appl. Mater. Interfaces, 2014, 6, 8909-8912; or Y. Geng at la., in Sci. Rep., 2016, 6, 26840, to name just a few) the underlying 2D patterns are generally easy to decode (and, as a result, to clone or reproduce due to the relatively limited density of information of such patterns. One example of a manifestation of this problem is provided by the Apple Inc.'s launching Face ID (3D pattern) to replace Touch ID (2D pattern) as an authorization system for their latest smart devices (e.g., iPhone, iPad) in late 2017 (see Z. Y. Huang et al. in J. Mech. Phys. Solids, 2005, 53, 2101-2118), where the former was claimed to be 20 times more secure due to the additional depth information mapped with its TrueDepth camera system.

To date, to the best knowledge of the applicant, no 3D PUF system has been reported for anti-counterfeiting applications because of the grand challenges in both the fabrication and authentication approaches.

### SUMMARY

Embodiments provide a physical unclonable function (PUF) that includes a layer of a 2D material having a top surface containing creases, and a substrate carrying such layer. In at least one case, the PUF does not contain a gap between the substrate and the layer of a 2D material and/or the layer of a 2D material is laminated between the substrate and a layer of optically transparent material. Substantially in every implementation, the creases are stochastic creases extending along a normal to a surface of the substrate (that, optionally, may include a curved surface). Alternatively or in addition, and substantially in every implementation, the PUF has encoding capacity that is equal to a value resulting from an exponentiation of a base integer raised to the power of an exponent, where the exponent is equal to a number of pixels to the power of three; and/or at one or more of the following conditions is satisfied: (a) the substrate includes an elastomeric material configured to undergo shrinkage in a plane of the substrate when exposed to an elevated temperature, (b) the 2D material includes at least one of a graphene-based 2D material, a silicate clay, a layered double hydroxide (LDHs), a MXene, a transition metal dichalcogenide (TMD), and a transition metal oxide (TMO), (c) the substrate includes a thermally-responsive shrink layer of material having a glass transition temperature and configured to shrink when exposed to a temperature exceeding said glass transition temperature and/or a pre-stretched elastic layer configured to release at a temperature substantially equal to a room temperature.

Embodiments further provide a method for fabrication of the PUF configured as discussed above. Such method includes disposing a layer of a 2D material that has tangentially-parallel to each other surfaces on a surface of a substrate made of a pre-determined material to form a first stack that includes the substrate carrying said layer (the substrate may possess a curved surface); and changing a geometrical characteristic of the substrate to crumple the layer of a 2D material to form a second stack in which a crumpled layer of the 2D material has a top surface containing creases. The method may additionally include a step of forming the second stack in which creases include creases stochastically distributed along the substrate, and/or a step of forming the first stack devoid of a first gap between the layer of the 2D material and the surface of the substrate while the second stack is substantially devoid of a second gap between the crumpled layer of the 2D material and the substrate. Alternatively, or in addition, and substantially in any implementation, the method may include a step of laminating either the layer of the 2D material with mutually tangentially-parallel surfaces or the crumpled layer of the 2D material with an optically-transparent material. Alternatively or in addition, and substantially in every implementation of the method, the substrate may include at least one of a layer of a thermally responsive material having a glass transition temperature and a pre-stretched elastic layer, while the step of changing may include one or more of (a) shrinking the layer of a thermally responsive material by exposing the substrate to an elevated temperature exceeding the glass transition temperature and (b) releasing the pre-stretched elastic layer at a room temperature.

Moreover, embodiments provide a method for authentication of the PUF structured as discussed above by performing at least the following steps: generating a first optical image of the top surface containing creases; storing such image in on a tangible, non-transitory storage medium at a first moment of time; generating a second optical image of the top surface containing creases at a second moment of time that is subsequent to the first moment of time; and comparing the second image with the first image with the use of a depthwise-separable convolution network. The step of comparing may include comparing the second image with the first image to define a dissimilarity matrix and/or deriving a dissimilarity index with the use of a Siamese neural network. At least one implementation of the method for authentication is configured such that a result of the process of comparing is substantially independent from at least a linear shift and/or a degree of rotation and/or a degree of tilt and/or a level of resolution and/or contrast of an image under investigation as well as independent from a level of optical power with the use of which such image has been acquired (and, as a result of it, from a level of irradiance of the image).

### BRIEF DESCRIPTION OF THE DRAWINGS

The implementations of the discussed idea will be more fully understood by referring to the following Detailed Description of Specific Embodiments in conjunction with the Drawings, of which:

FIGS. 1A, 1B schematically illustrate the principle of scalable (that is, lending itself to simple mass production) fabrication of an embodiment based on but one specific example of fabrication of a 3D MXene crumple PUF, as well as the results of characterization of the MXene layer.

FIGS. 2A, 2B, 2C, and 2D schematically depict fabrication of 3D crumple physically unclonable functions and their application towards artificial intelligence (AI)-driven anti-counterfeiting. FIG. 2A: (A) Simple and scalable fabrication of 3D MXene crumple PUFs (see FIG. 1) optical characterized with confocal microscopy; FIG. 2B: a schematic illustration of analogy between a system employing optical characterization and/or anti-counterfeiting system of an embodiment of a PUF structured according to the disclosed idea and the Face ID authorization system by Apple Inc. FIG. 2C shows the mass-produced embodiments of the 3D PUF tags attached to the mass-produced products, which were then (i) scanned with a portable laser confocal microscope containing optical imaging system in a layer-by-layer fashion to thoroughly extract the 3D structural information contained in such PUF tags. Thereafter, the resulting 2D laser images were (ii) reconstructed to form the 3D PUF keys each containing the extracted comprehensive structural information, which is (iii) registered in the database and used to (iv) train the Siamese neural network (SNN) algorithm for future authentication. FIG. 2D: After the receipt of the product, the distributor/customer first (i) reads and reconstructs the 3D crumple PUF, which then is (ii) authenticated using an embodiment of the authentication algorithm.

FIGS. 3A, 3B schematically illustrate an embodiment of the Siamese neural network (SNN) authentication algorithm and the training process. FIG. 3A: Design of the SNN framework for comparison between a pair of embodiments of the 3D PUF keys. FIG. 3B: Training and test processes of an embodiment of the SNN algorithm.

FIGS. 4A, 4B, 4C, 4D, 4E, and 4F illustrate comparison of the discussed embodiment of the 3D PUF employing system with PUF systems of related art. Schemes and dissimilarity matrixes of an embodiment of the 3D crumple PUF system (FIG. 4A), 2D crumple PUF system (FIG. 4B), and state-of-the-art 2D PUF systems (FIG. 4C) are presented, where their inter-key dissimilarities were quantified using the SNN algorithm. FIG. 4D presents a schematic illustration of the advantage of 3D PUF over 2D PUF in terms of their encoding capacity. Disclosure embodiments of 3D PUF system demonstrate all-around advantages in encoding capacity (FIG. 4E), processing time, and security levels (FIG. 4F) as compared to state-of-the-art PUF systems.

FIGS. 5A, 5B, 5C illustrate robust authentication of an embodiment of a 3D crumple PUF system disclosed herein. The diverse human/machine factors show neglectable effects on obtained 3D PUF keys (FIG. 5A) and the resulting dissimilarity matrices (FIG. 5B) when cross-comparing with the original 3D PUF key. FIG. 5CL Box plot representing the D distributions when the trained SNN is applied to the 3D PUF test set and the 2D PUF test set.

FIGS. 6A, 6B, 6C, 6D, and 6E illustrate pick and authenticate strategy that enables robust authentication(s) of an embodiment which authentication is substantially free and independent from variations in position or rotation of the embodiment. FIG. 6A: Steps of locating a 3D PUF pattern, extracted at the customer side, within the larger pattern in a database; and the chosen algorithm-based (here—the embodiment of the disclose SNN algorithm) comparison between the corresponding PUF keys. FIG. 6B: illustration of Position-Insensitive Authentication. FIG. 6C: Illustration of Rotation-Insensitive Authentication. FIGS. 6D, 6E represent PUF keys with various positions or rotations and the corresponding PUF keys from the large area pattern in the database.

FIG. 7 is a schematic illustration of embodiments of 3D PUF tags applied in the supply chain with an anti-counterfeiting system.

FIGS. 8A, 8B illustrate a stochastic structure of the surface of a discussed embodimentof the PUF of in top view and a view with a tilt, respectively.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

A disclosure of each of various documents listed and/or referred to in this patent application is incorporated by reference herein, except for any statement contradictory to the express disclosure of this patent application, subject matter disclaimers or disavowals, and except to the extent that the incorporated material is inconsistent with the express disclosure of this application, in which case the express language of this disclosure controls.

As a skilled artisan readily recognizes, no 3D PUF system has been reported to date for anti-counterfeiting applications because of the challenges both with the fabrication and authentication of a 3D PUF. In particular, the substantial size of a 3D PUF pattern (as compared with that of conventional 2D PUFs) limits its practical use. Indeed, for the use of a 3D PUF to justify the costs of manufacturing, a 3D PUF t should be small enough (about a millimeter in size) to be easily attached to a chosen product while, at the same time, possessing rich structural information. This demands highly delicate fabrication. In terms of authentication of 3D PUFs, typical methods needed to extract a large amount of data representing rich and complex structural information of the 3D patterns include electron imaging (e.g., scanning electron microscopy) and contact tapping (e.g., atomic force microscopy, surface profilers, etc.). The processes of setting up of any of these imaging modalities are conventionally too bulky and expensive. Notably, as known, highly professional staff training and tedious pattern extraction processes are normally involved to properly authenticate a 3D PUF, making 3D PUF systems currently impractical for facile and time-efficient recognition and/or authentication by regular distributors or customers.

Another challenge with 3D PUF systems lies in authentication, as well as the large quantity of PUF keys, raising high demand for time-efficient pattern recognition and validation.

All these deficiencies of the practical usage of 3D PUFs begs a question of whether it is possible to produce a PUF label, key, or system that—while possessing a substantially 2D structure and, for that very reason, lending itself to rather mundane and well-recognized methodologies of characterization—would nevertheless be possessing a degree of encoding capacity and/or robustness of authentication similar to or exceeding those associated with a 3D PUF.

In accordance with the discussed implementations, articles of manufacture are disclosed embodying uniquely configured three-dimensional layered PUFs that retain a substantially single active layer-based structure, and related methods of fabrication and use of same.

The idea implemented in discussed-below embodiments stems from the realization that the use of a layer of an ultra-thin material (known in the art as 2D material or 2DM—such as graphene oxide, Ti₃C₂Tₓ, for example) judiciously structurally modified or transformed such as to obtain or acquire stochastically-distributed wrinkles defining surface relief or features extending out-of-plane of such layer results in a combination of properties that are starkly advantageous over those of the conventional 2D PUFs. On the one hand, the modification of a layer of the 2DM by such “crumpling” clearly results in increased dimensionality of the crumpled 2DM layered structure (thereby prompting the use of such structure in diverse applications where high specific area and complexity of the structure are demanded) and, on the other hand, such modification retains a single layer configuration that, due to the presence of the now-present surface relief, defines the increased encoding capacity of a PUF containing such layer. The embodiments of the resulting microstructure are referred to herein as a 3D crumple structure, and a PUF utilizing an embodiment of a 3D crumple structure is referred to as a 3D crumple PUF.

Accordingly, problems caused by PUFs of related art, manifesting in at least physical instability and relative ease of decoding (or, stated differently, low level of security—which in turn is caused by the relatively limited information density characterizing such conventional PUFs) are solved by devising a PUF that includes a layer of a 2D-material that is crumpled or wrinkled stochastically such as to form a surface relief containing features with random geometry protruding out of plane of the layer of such material.

For the purposes of this disclosure and appended claims—and unless expressly defined otherwise—the following terms have the meanings as stated.

The term “active layer”—and, in particular, active layer of 2D material—refers to the layer of the PUF structure that defines encoding capacity and is responsible for anti-counterfeiting properties of the PUF structure.

The term two-dimensional (2D) material refers to a class of nanomaterials defined by their property of being merely one or two atoms thick, crystalline materials consisting of single- or few-layer atoms, in which the in-plane interatomic interactions are much stronger than those along the stacking direction. With a thickness of such materials being a few nanometers or less, electrons in these materials are free to move in the two-dimensional plane, but their restricted motion in the third direction is governed by quantum mechanics. Prominent examples of 2D materials include quantum wells and graphene, graphene oxide (Ti₃C₂Tx), silicene, molybdenum disulfide (MoS₂) (see, for example, nature.com/subjects/two-dimensional-materials, azom.com/article.aspx?ArticleID=12828matse.psu.edu/2d-materials, for example, contents of which are incorporated herein by reference).

Stochastic means randomly determined; having a random probability distribution or pattern that may be analyzed statistically but may not be predicted precisely.

When one layer of materials carries another layer of material it means that the second layer is either disposed directly on and in physical contact with the first layer or that the second layer is disposed on an intermediate layer that, in turn, is carried by the first layer. Similarly, when a material layer is carried by a substrate, it means that the material layer is either disposed directly on and in physical contact with the substrate or on an auxiliary material layer that, in turn, is carried by the substrate.

A gap is defined as space or interval unfilled with a material different from air, a break or hole in an object or between two objects. The term subsequent means and is defined as coming after something in time, following in time.

The person of skill in the art now readily appreciates that the great handleability and stability of 2DMs, as well as their scalability in producing random and unclonable physical micro-patterns make the devised 3D crumple microstructure (containing a single active layer of crumpled 2DM) a competitive candidate for use as and instead of a conventional PUF pattern or structure (which, according to related art, utilizes multiplicity of physical active layers).

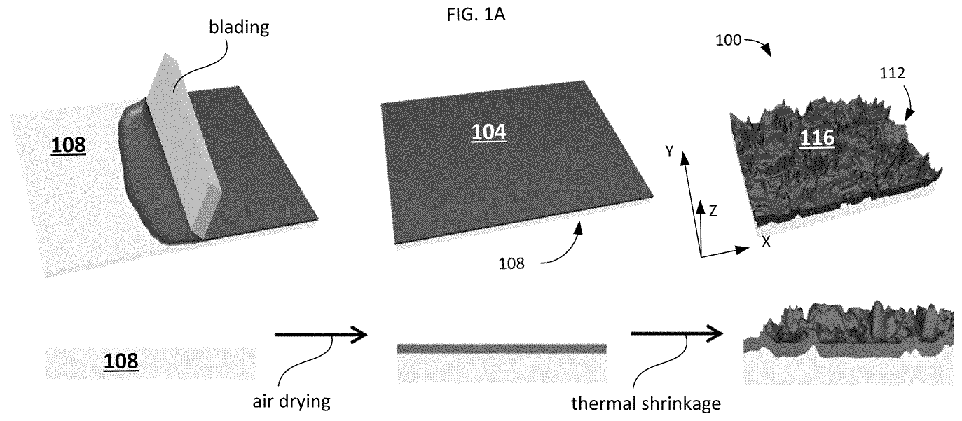

To this end, FIG. 1A schematically illustrates an embodiment of the method for fabrication of a 3D crumple PUF 100 (here—a 3D MXene crumple PUF), based on the unique out-of-plane 3D topography generated from the ultrathin planar MXene layer 104 attached to (carried by) an elastomeric substrate 108. In this embodiment, the substrate 108 carrying the single planar layer 104 is made or caused to undergo in-plane contractions, while the mechanical dissonance at the MXene/substrate interface (manifesting in different material properties of MXene layer and the substrate) transforms the initially substantially planar surface of the layer 104 into a surface 112 containing multiple wrinkles and creases, thereby modifying the substantially planar layer 104 into a crumpled layer 116.

In one implementation, the MXene dispersion was initially uniformly coated (areal loading of 0.32 mg cm⁻², by doctor blading) onto the thermally responsive polystyrene substrate, as shown in FIG. 1. After air drying of the single MXene layer, the substrate 108 was thermally treated at 140 deg C. (the temperature exceeding its glass transition temperature) to undergo thermal shrinkage while the initially substantially spatially-uniform MXene layer 104 (with a thickness of about 1.0 μm) crumpled randomly, due to the shrinkage of the underlying substrate, to form large-area, stochastic 3D single-layer pattern, thereby forming the embodiment 100. The sample 100 could and was further cut into pieces of interest (here, pieces of about 3×3 mm²) for further use. Characterization details of the MXene nanosheets and the generated 3D crumples are shown in FIG. 1B.

The crumpling process can be expressed with the classic equation for wrinkles generated in a thin film that is compliantly bonded to an elastomeric substrate, as shown in Equation 1 (see Z. Y. Huang et al., J. Mech. Phys. Solids, 2005, 53, 2101-2118):

λ=2πh(Ē_{f}/3Ēₛ)^{1/3} (1),

where λ is the characteristic wavelength of a wrinkle, h is the thickness of the film 104, E_{f} and Eₛ are the Young's moduli of the top-layer film and the bottom-layer substrate, respectively; Ē=E/(1−v²); v is the Poisson's ratio. By harnessing the interfacial instability of the employed thermal shrinkage process, the topography of the surface 112 of crumpled MXene layer 116 was intrinsically and necessarily disordered and stochastic, thereby lending the embodiment 100 to be an ideal candidate for a 3D PUF key or tag or system in an anti-counterfeiting application.

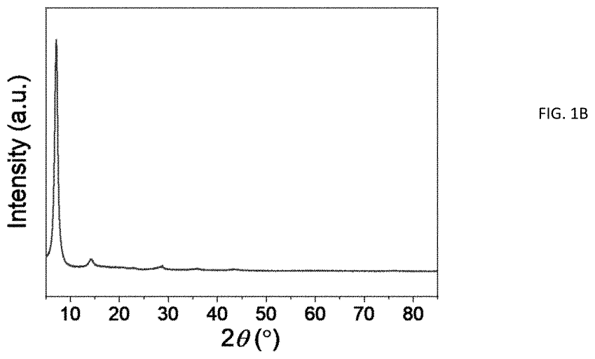

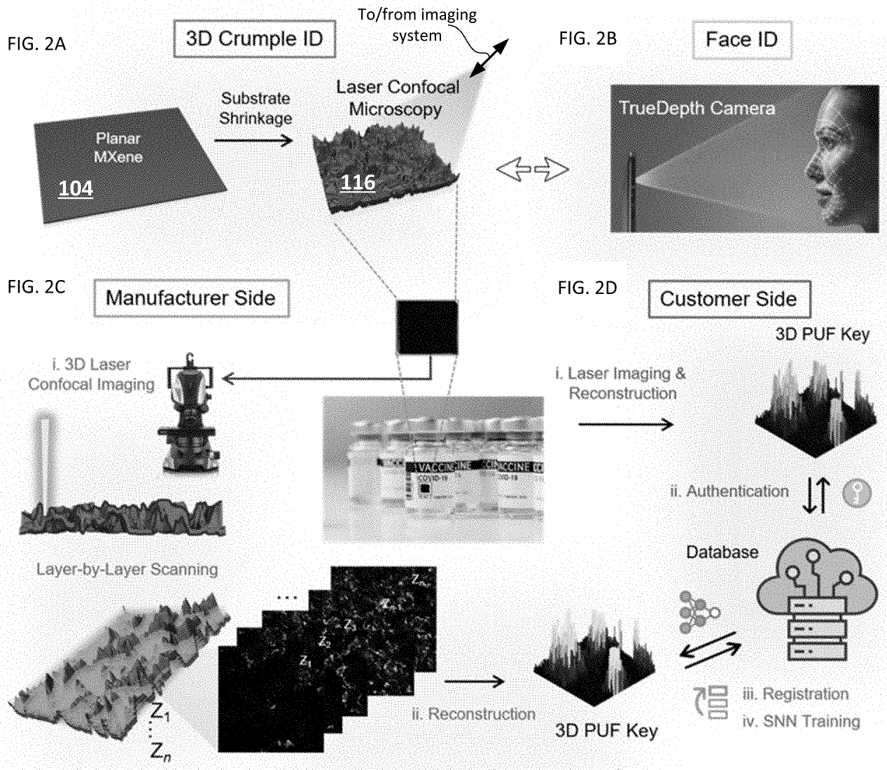

A person of skill may think of the embodiment 100 of a 3D crumple PUF or ID anti-counterfeiting system as being somewhat analogous to the Face ID authorization system launched by Apple Inc, as illustrated in FIG. 2B, since in both cases the additional depth (height) information from either the 3D PUF pattern or the human face is used to enable more secure authentication. As shown in FIG. 2C, the as-produced 3D crumple PUF tags can be easily formatted with demanded sizes (for example, simply cut into pieces without sacrificing the single active layer configuration) and attached to mass-produced products (e.g., containers with COVID-19 vaccines). Furthermore, one of the clear advantages of practical utilization of the proposed embodiment 100 of the PUF is that, due to the retained after the crumpling process single layer nature of the embodiment, a simple conventional unsophisticated optical imaging can be employed to reliably and thoroughly extract all available 3D structural information from such a PUF. As a non-limiting example—and as pictorially indicated in FIGS. 2A and 2C—the single-layer nature of the tag 100 allows such tag to be simply imaged, by scanning through depth (along the axis 210 that is substantially transverse to the layer 116) with a portable laser confocal microscope containing imaging system, in a depth-by-depth fashion. A typical scanner needed for such a purpose requires only a minimal laser power of 0.3 μW, which is substantially lower than the 1 mW power of a daily-use laser pointer).

A person of ordinary skill int eh art will readily appreciate that, more generally, the substrate 108 can be chosen to include at least one of a shrinking thermally responsive material as a non-limiting example—polystyrene and polyolefin and/or that a glass transition temperature of which is about 100 deg C. to 150 deg C.) and a pre-stretched elastic material, while the methodology of crumpling a chosen substantially planar layer of the 2D material 104 formed on such substrate may include at least one of exposing the substrate/2D material layer stack to temperature elevated about the glass transition temperature of the substrate material and releasing the pre-stretched elastic substrate at the temperature substantially equal to room temperature. Non-limiting examples of applicable 2D materials include graphene-based 2D materials, silicate clays, layered double hydroxides (LDHs), MXenes, transition metal dichalcogenides (TMDs), and transition metal oxides (TMOs).

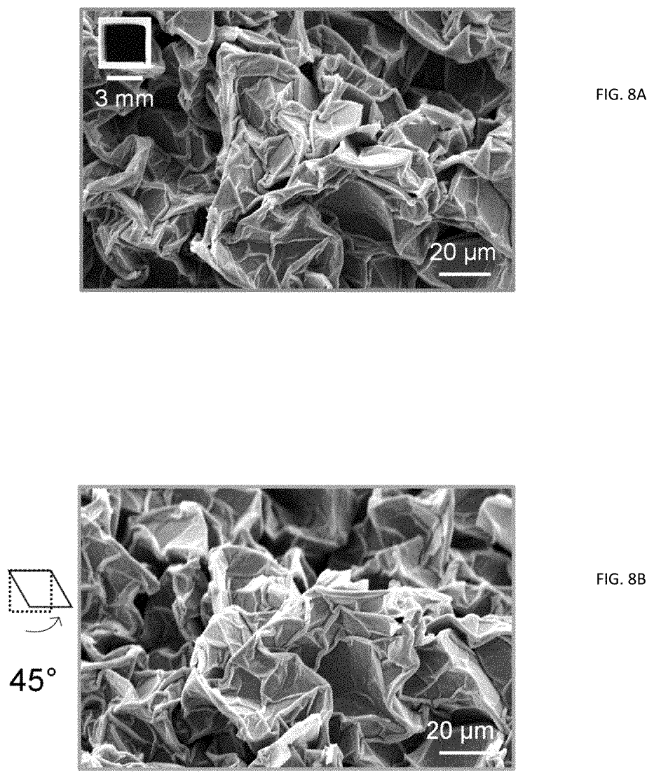

As indicated in FIGS. 8A and 8B, showing respectively the top and tilt views of a representative embodiment of a 3D crumple PUF structured according to the presented idea, the 3D crumple PUF structure demonstrates not only stochastic distribution in an (x, y) plane i but also unique information/characteristics along the z axis. As such, to comprehensively extract the 3D information of the single active layer of the embodiment 100, the layer-by-layer laser imaging “slice up” the 3D crumple structure to collect the comprehensive structural details from bottom to top (or the other way around). Typically, a set of ˜60-70 2D laser image frames (taken along the, z direction) with dimensions of 248×248 μm² (512×512 pixels, x-y plane) was extracted for an individual 3D crumple PUF tag such as the tag 100. Thereafter, the resulting 2D laser images were reconstructed using the Gridrec algorithm (see B. Dowd et al., Developments in synchrotron x-ray computed microtomography at the National Synchrotron Light Source, SPIE, 1999) with TomoPy (A. G. Howard et al., arXiv preprint arXiv: 1704.04861, 2017) to form the corresponding 3D PUF key with comprehensive structural information, which was then registered in the database and used to train a chosen algorithm (as discussed below—a self-developed Siamese neural network, SNN, algorithm for future authentication of the tag(s). On the other hand, from the distributor/customer perspective (as is schematically illustrated in FIG. 2D), the 3D crumple PUF tag will be first read and reconstructed, and then synced and further authenticated using the same algorithm.

A skilled artisan now readily appreciates that a discussed embodiment includes a physical unclonable function that contains a single layer of a 2D material having a top surface with creases or wrinkles extending away from the single layer, and a substrate carrying such layer of a 2D material thereon. In at least one case, there is substantially no delamination between the substrate and the layer of a 2D material and, optionally, the layer of the 2D material may be overcoated with a layer of optically transparent material (which is not an active layer of the structure) for the purposes of mechanical protection, for example. An embodiment of a method for fabrication of such PUF includes at least a step of disposing a layer of the 2D material (such that surfaces of this layer are substantially tangentially parallel to one another) on a surface of a substrate made of a pre-determined material to form a first stack that includes the substrate carrying such layer of the 2D material, and the step of changing a geometrical characteristic of the substrate to crumple the layer of the 2D material to form a second stack in which a crumpled layer of the 2D material has a top surface containing the creases or wrinkles. In at least one implementation, the step of changing the geometrical characteristic (such as an extent) of the substrate may include the process of shrinking the substrate by exposing it to an elevated temperature.

While the process of authentication of an embodiment of the 3D crumple PUF configure according to the above-presented idea may be performed in different ways, a customized Siamese neural network SNN framework judiciously designed based on a Depthwise-separable convolution network (A. G. Howard et al., arXiv preprint arXiv: 1704.04861, 2017; L. Nanni et al., Applied Sciences, 2020, 10, 4176) was used in one implementation, considering promising capability of the SNN network to decode and process high dimensional data In addition, the SNN is known in related art for its strength to constantly learn and perform intrinsic robustness regardless of the input data quality. (For example, SNN can be adopted by the Face ID system to tackle the challenges in authorizing the users with ever-changing characteristics, e.g., wearing hats, scarves, glasses, most sunglasses, facial hair, or makeup). In our case, various influences and/or conditions present during the extraction of a PUF key would not affect the results of authentication performed with the use of the SNN network, thereby rendering the developed method for authentication to be substantially independent from at least linear shift and/or rotation and/or tilt and/or level of resolution and/or contrast of an image under investigation as well as independent from a level of optical power with the use of which such image has been acquired (and, as a result of it, from a level of irradiance of the image).

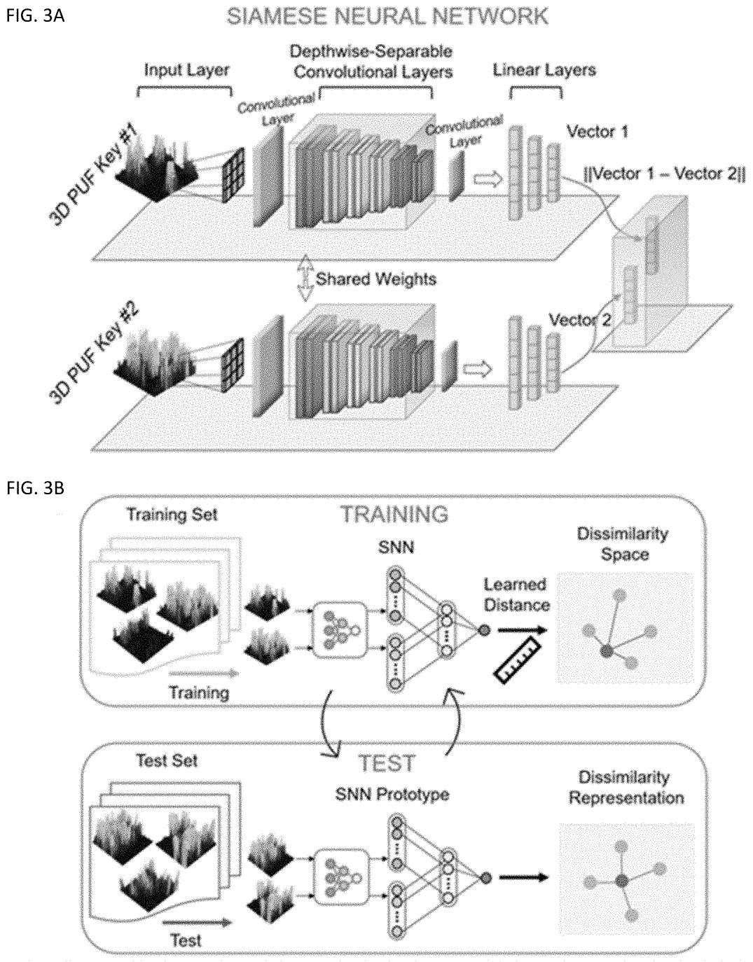

The design of an embodiment of the target SNN framework for use in authentication of an embodiment of the 3D crumple PUF is schematically shown in FIG. 3A. The SNN framework contains 12 Depthwise-separable convolutional layers as the body and 2 convolutional layers located at the beginning and the ending of the framework. In particular, Depthwise-separable convolution was the combination of two convolution steps, which were Depthwise convolution and pointwise convolution, respectively, producing a similar effect as the conventional convolution layer combined with the pooling layer. In addition, by connecting these two convolution operations or steps, the output of the same dimension as that of the conventional convolutional neural network (CNN) was be achieved with much fewer design parameters (1.4% of the conventional convolution, 6.3×10⁷ vs. 4.4×10⁹ in this case). As such, Depthwise-separable convolution greatly improved the computational efficiency and maximum depth of the devised verdion of the neural network, leading to an accelerated processing speed as compared to that of a conventional SNN framework.

To maximize the capability of the SNN framework in distinguishing different 3D PUF keys, training and test were conducted as illustrated in FIG. 3B. First, the whole 3D PUF key database was separated into two datasets, a training set, and a test set, respectively. Then, a dissimilarity space was created using an SNN trained on the entire training set to define a distance function among the 3D PUF keys. Theoretically, all the training samples could be considered as centroids of the dissimilarity space. In this space, the SNN was used to compare the 3D PUF key to every centroid, obtaining a dissimilarity vector (distance, D) that quantified the difference between a certain pair of 3D PUF keys, with a larger D indicating a higher degree of dissimilarity. The training phase was aimed at maximizing the distance between different (FAKE) 3D PUF keys (e.g., 595 pairs).

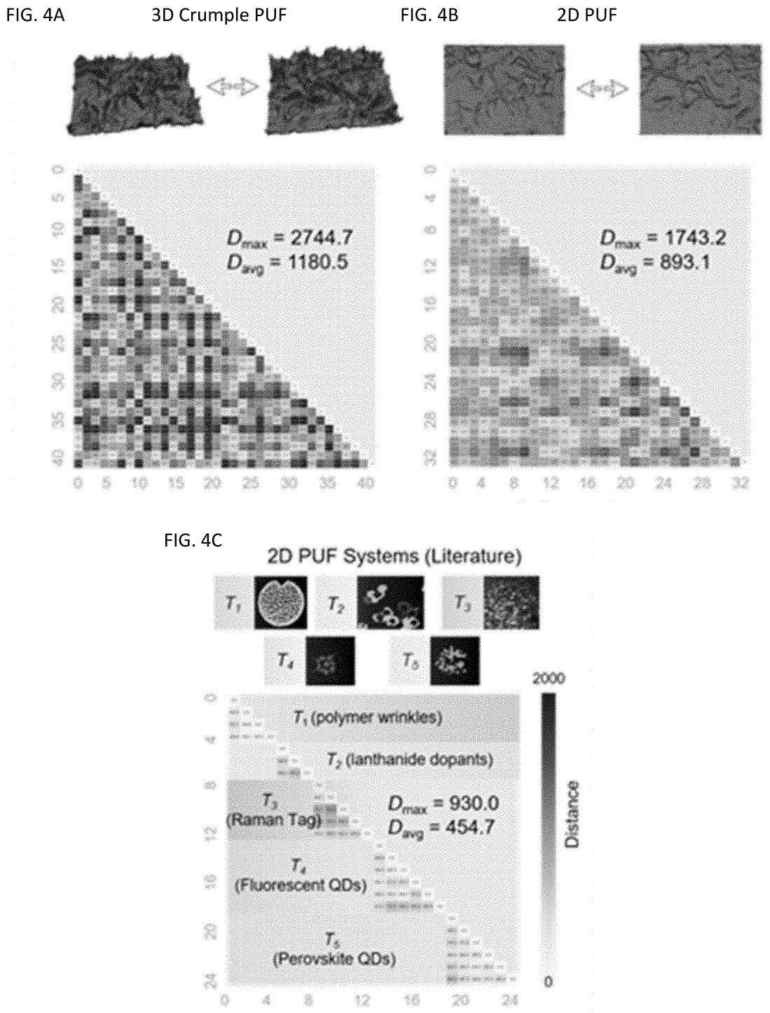

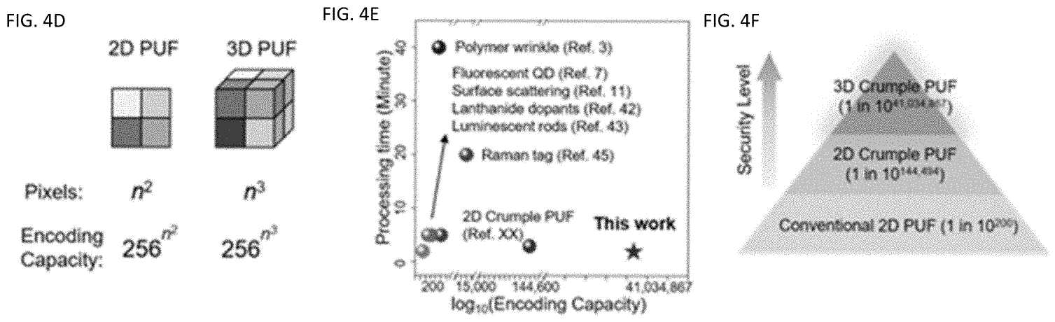

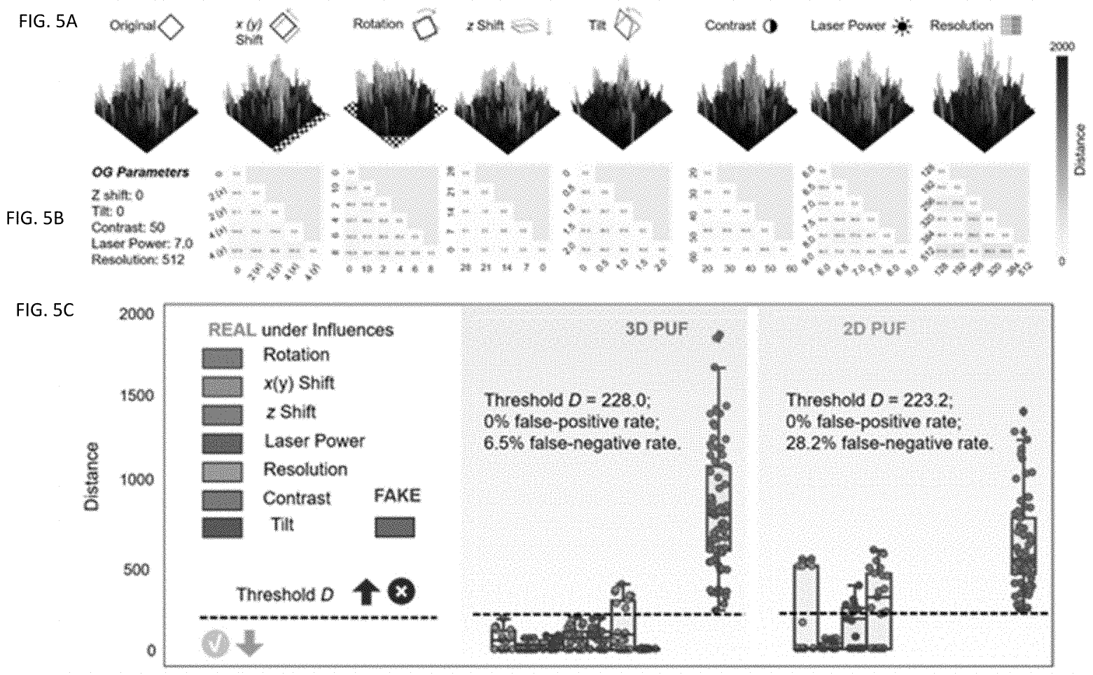

Meanwhile, the other goal was to minimize the distance between similar 3D PUF keys collected from the same (REAL) PUF pattern under various influences (e.g., z shift, x (y) shift, rotation, tilt, resolution, contrast, and laser power), thereby cultivating and ensuring the robustness of the embodiment of the SNN framework to diverse human/machine factors during pattern extraction using conformal laser microscopy. These training processes were accomplished by adjusting the SNN framework embodiment (e.g., m value of contrast loss function, number of layers, activation function, normalization function for each layer) based on the contrast loss function. (Here, when the SNN prototype under training reaches a certain standard—that is, a threshold D can be selected to differentiate the REAL and FAKE patterns, thereby ensuring substantially 0% false-positive with low false-negative rates—it can be sent to the test phase to check its practical applicability.) In one implementation of the test phase, the 3D PUF keys in the test set (e.g., 78 FAKE pairs, 130 REAL pairs) were compared using the SNN prototype and obtain the D distribution for both groups. The D distribution was then reviewed regarding the potential false-negative and false-positive rates at a certain threshold D, which was considered to evaluate the applicability of the SNN prototype. If the false-negative and false-positive rates from the test set were not low enough, the SNN prototype was sent back to the training phase to conduct the 2^{nd} train-test cycle, where further adjustments were applied to the SNN parameters, followed by further evaluation using the test set. In at least one practical implementation, 8 train-test cycles were conducted to achieve the demanded performance. The embodiment of the trained SNN algorithm was then used to quantify and compare the dissimilarity index (i.e., the extent of dissimilarity between different PUF keys) between an embodiment of the 3D crumple PUF system (configured as discussed above) with PUF systems of related art. The results of such comparison are presented in FIGS. 4A, 4B, and 4C. First, the uniqueness of the embodiment of the 3D crumple PUF keys was quantified by cross-comparing 40 different 3D crumple PUFs using the above-discussed well-trained SNN algorithm, as shown in the dissimilarity matrix (FIG. 4A), where the maximum D (labelled as Dₘₐₓ) and average D (denoted as D_{avg}) were extracted to be 2744.7 and 1180.5, respectively. As a comparison, the PUF system the three-dimensional structure of which was acquired/extracted with the use of SEM (see L. Jing et al., Matter, 2020, 3, 2160-2180) demonstrated a Dₘₐₓ of 1743.2 and D_{avg} of 893.1 based on a cross-comparison of 32 different 2D crumple PUF keys, as presented in FIG. 4B. Notably, the D_{avg} for 2D crumple PUF system is substantially smaller as compared to that of the 3D crumple PUF system that was configured according to the idea discussed above. In addition, parameters of five types of conventional 2D PUF systems were summarized based on publicly available related art and further compared with the discussed embodiment of the 3D crumple PUF with the use of the embodiment of the trained SNN. Among these conventional 2D PUIF systems there were polymer wrinkles (T₁, 4 patterns), see H. J. Bae, et al., Adv. Mater., 2015, 27, 2083-2089; lanthanide dopant (T₂, 3 patterns), see M. R. Carro-Temboury et al., Sci. Adv., 2018, 4, e1701384; Raman tag (T₃, 5 patterns), see Y. Gu et al., Nat. Commun., 2020, 11, 516; fluorescent quantum dots (QDs, T₄, 6 patterns), see Y. Liu et al., Nat. Commun., 2019, 10, 2409; and perovskite QDs (T₅, 6 patterns), see Y. Liu et al., ACS Appl. Mater. Interfaces, 2020, 12, 39649-39656. The resulting dissimilarity matrix (FIG. 4C) shows a Dₘₐₓ of 930.0 and D_{avg} of 454.7, respectively, which values are comparable with those of the 2D crumple PUF keys yet much lower than those exhibited by the proposed embodiment of the 3D crumple PUF system.

The thus demonstrated high degree of uniqueness of embodiments of the 3D crumple PUF in comparison with any PUF of related art originates from its potential to encode a higher density of information, which in turn leads to its higher encoding capacity (i.e., the available number of distinct patterns). As schematically illustrated in the example of FIG. 4D, assuming that a conventional 2D PUF key contains n² pixels (in the x-y plane), on top of which a 3D PUF key may contain additional pixels in the z-direction with a higher pixel count of n³. If each pixel has 256 variations in grayscale (that is, intensity varying from 0 to 255), the theoretical encoding capacities of conventional 2D PUF and 3D PUF systems are 256ⁿ^{²} and 256ⁿ^{³}, respectively. As a skilled artisan having an advantage of this disclosure will appreciate, in the case of the proposed 3D crumple PUF system, the upgrade in dimension from 2D to 3D (caused as a result of the crumpling process) contributes to a significant leap in encoding capacity from 10^{144,494} to 10^{41,034,867}, which differential is even higher when compared with the state-of-the-art conventional PUF systems, as shown in FIG. 4E.

Furthermore, by improving the pattern extraction approach from the previously employed in related art SEM imaging (for 2D crumple PUF) to the currently-employed 3D laser imaging (with the use of confocal microscopy), the processing time was further shortened from 3.5 minutes to 2 minutes. The unequaled encoding capacity and very short (minute-level) processing time of the proposed 3D crumple PUF system stand out as stark contradistinctions to and from also state-of-the-art 2D PUF systems.

Yet another way to evaluate a PUF system is to determine its security level, as shown in FIG. 4F. Here, for conventional 2D PUF systems with encoding capacities up to 10^{144,494}, the chance of randomly reproducing a PUF key is 1 in 10^{144,494}. For an embodiment of the 3D crumple PUF system discussed in this disclosure, however, the chance of reproducing the same PUF key is 1 in 10^{41,034,867}, which is significantly lower and poses a high technological barrier for potential counterfeiters.

Moreover, in addition to high level of security and ability to be authenticated extremely fast, another impressive advantage of the proposed 3D crumple PUF system is its authentication robustness to diverse extraneous influences from human/machine factors. In particular, it is known from related art that for 2D PUF based anti-counterfeiting systems, the authentication result is sensitive to the designated location, angle, and image quality of the extracted pattern. This is because these factors significantly affect the obtained information, which thus leads to potential negative authentication even when the PUF is REAL itself (i.e., the false-negative case). On the other hand, during the extraction of the PUF pattern by thorough depth-by-by and bottom-to-top laser imaging, as was done with the embodiment of the discussed 3D crumple PUF, the 3D structural information is comprehensively examined and collected while preserving most if not all of its structural details. As such, even when certain factors may affect somehow the optical extraction of the 3D PUF pattern to some extent, the extracted information still remains sufficient to support the accurate authentication and minimize the false-negative cases. In our case, to verify the authentication robustness of the proposed 3D crumple PUF system, diverse factors anticipated in practical scenarios were applied on purpose, intentionally while optically extracting/imaging/characterizing a specific 3D PUF pattern, as schematically illustrated in FIG. 5A. These extraneous factors considered were—x- and/or y-shift (that is a lateral shift of the pattern under investigation in the x-y plane, 2% and 4% in x-direction, 2% and 4% in y-direction), rotation (rotation in x-y plane, 0°, 2°, 4°, 6°, 8°, 10°), z shift (shift of pattern in the height direction, 0%, 7%, 14%, 21%, and 28%), resolution (128×128, 192×192, 256×256, 320×320, 384×384, 512×512), contrast (20, 30, 40, 50, 60), and laser power (6.0, 6.5, 7.0, 7.5, 8.0, 9.0), where obvious variations can be observed in the real-time optical images. The acquired sets of laser images were reconstructed to form the 3D PUF keys under these extraneous influences and cross-checked with the original 3D PUF keys, where the resulting dissimilarity matrixes are shown in FIG. 5B. Impressively, even under the influences of these diverse human/machine factors, the parameter(s) D (characterizing dissimilarity between the extracted 3D PUF patterns and the original 3D PUF keys) is/are relatively low, with D_{avg} and Dₘₐₓ of 65.2 and 382.2, respectively. These observed D_{avg} and Dₘₐₓ are distinctly lower than the D values representing dissimilarity between different 3D PUFs (2744.7 and 1180.5, respectively), and could be differentiated easily. To be specific, the observed/derived D values were unambiguously insensitive to the presence of z shift (D_{avg}=3.1), tilt (D_{avg}=47.6), contrast (D_{avg}=64.8), while relatively sensitive to the presence of x(y) shift (D_{avg}=98.3), rotation (D_{avg}=95.7), laser power (D_{avg}=97.3), and resolution setting (D_{avg}=198.4) because of the change in information captured.

The robust pattern extraction of the 3D PUF pattern from the embodiment of the 3D crumple PUF, combined with the used well-trained SNN algorithm discussed above directly contributed to the robust authentication of its derived anti-counterfeiting system, where D was chosen as the criterion. As was alluded to above, the SNN was trained to distinguish the FAKE from the REAL within the training set through cross-comparison of 945 pairs of 3D PUF keys. It could be observed that, with a threshold D, a 100% validation precision could be achieved with 0% false-negative and also very low false-positive rates, respectively. When this trained SNN was applied to the test set (208 pairs of 3D PUF keys), the results (see central portion or area in FIG. 5C) showed that a threshold D of 228.0 could be selected to ensure a 0% false-positive rate. In this case, the false-negative rate was calculated to be as low as 6.5% (8/124), which was explained by the resolution difference and could be easily avoided by keeping the consistent resolution setting throughout the database and authentication. Notably, as a skilled person will readily appreciate, although SNN itself possesses high intrinsic robustness to the quality of input PUF pattern, normally a huge quantity of samples in different states is needed for training to achieve high robustness of authentication. In stark contradistinction with related art, in our case with only a limited number of samples collected and input for training (945 pairs), the observed high robustness of authentication could be explained by the data collection and format of the 3D crumple PUF, as the different influencing factors do not affect much on the data extraction and thus the information of the discussed embodiment of PUF. In comparison, however, these human/machine factors affect a lot on the authentication robustness of the 2D crumple PUF system. As shown in the outmost right portion of FIG. 5C, to ensure a 0% false-positive rate, a threshold value of D of 223.2 was selected. In this case, a 28.2% false-negative rate could be observed, showing that 28.2% of the REAL 2D PUFs extracted under influences will be mis-authenticated as FAKE, where the rotation and x(y) shift, tilt, and rotation affect the most. This low authentication robustness may lead to particular and strict requirements regarding the pattern extraction process, which could be rather time-consuming with multiple authentication attempts anticipated.

It should be noted that among the four relatively sensitive factors that affect the authentication robustness, resolution and laser power of the embodiment of the optical imaging system with which PUF images are taken can generally be easily avoided by ensuring consistent settings throughout the database registration and authentication, while the x(y) shift and rotation could be affected easily by the positioning during the pattern extraction process, which will affect the authentication robustness of our 3D PUF keys to certain extents. According to the performed calculation, the D values between the x(y) shifted 3D PUF key and the original ones could easily exceed the threshold D of 228.0 when the x(y) shift is larger than 7%. A similar case exists when the extraneous rotation is larger than 12° in the x-y plane.

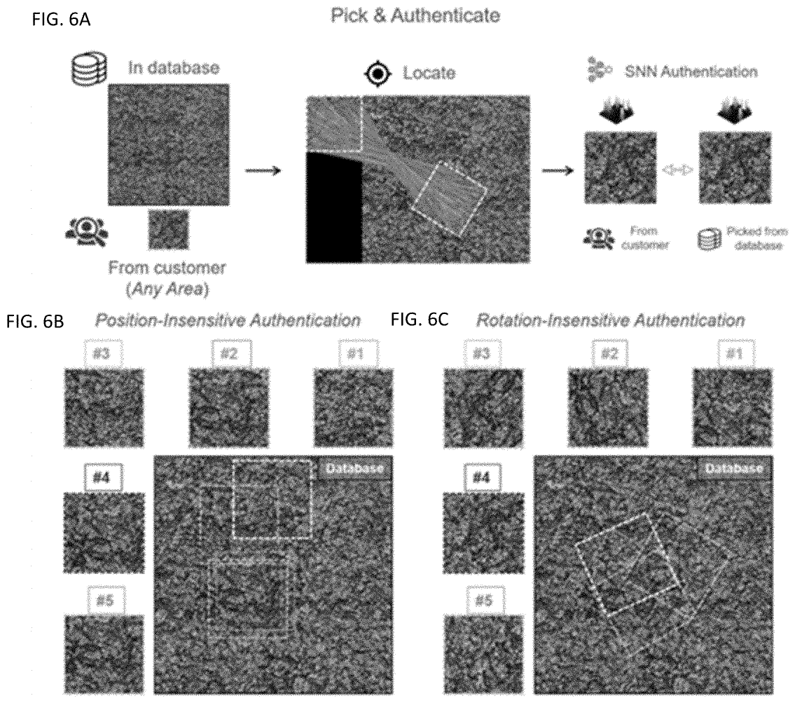

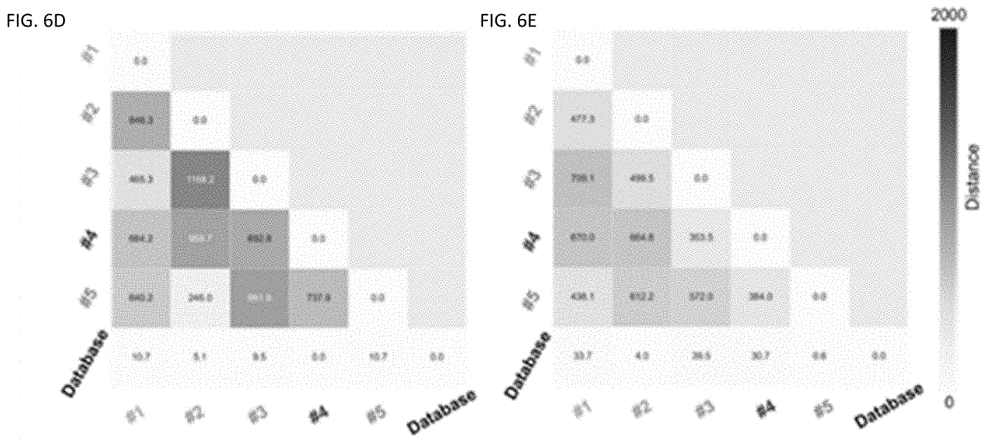

This relatively low tolerance on the extraneous factors involving positioning of PUF pattern could easily increase the false-negative authentication rates, which have been the critical issues that restrict their practical applications. To tackle this challenge, a pick and authenticate strategy was developed based on a large area 3D PUF key (whole PUF pattern of the tag) stored in the database and a smaller subarea 3D PUF key taken by the customer, as shown in FIG. 6A. The proposed strategy for solution included two basic steps: the comprehensive large area PUF key in a database was first traversed to locate and pick the smaller subarea PUF key from the customer relying on the similar characteristic points (e.g., Scale Invariant Feature Transform (SIFT) algorithm); then the picked corresponding area Was compared with the PUF key from the customer using the developed embodiment of the SNN algorithm we developed (FIGS. 3A, 3B). The first pick step ensured that any x(y) shift or rotation of the PUF key during the collection by the customer did not affect the information extraction (i.e., no information loss), as long as it was within the whole pattern area. As shown in FIG. 6B, no matter which position/area (#1 to #5) of the PUF pattern was imaged during the authentication, the specific area could be picked up precisely by the SIFT algorithm. Similarly, in the case of rotation during the laser imaging (FIG. 6C), the corresponding areas (#1 to #5) could also be easily picked up within the large area PUF key from the database. The precise picking/locating of the PUF patterns were attributed to the mechanisms of SIFT that rely on extraction and comparison of the key points of the PUF patterns, which are position- and rotation-invariant. After the picking step, the picked area from the large area PUF key was compared with the PUF key collected by a customer using the proposed embodiment of the SNN algorithm. Since the same 3D laser imaging methodologies (in this case, confocal microscopy) were adopted by the PUF key extraction for the database and by the customer, the same/similar information was encoded for the selected PUF keys, which were proved by the authentication results. As shown in FIGS. 6D and 6E, the D values between PUF keys with various positions or rotations and the corresponding (picked) PUF keys from the large area pattern in the database were quite low with D_{avg} of 7.2 and 21.7, respectively. A person of skill in the art would appreciate that these values are substantially lower than the selected threshold value of D of 223.2, thereby ensuring no false-negative authentication results for the cases of random position and/or rotation of the discussed embodiments of 3D crumple PUF prior to authentication procedure.

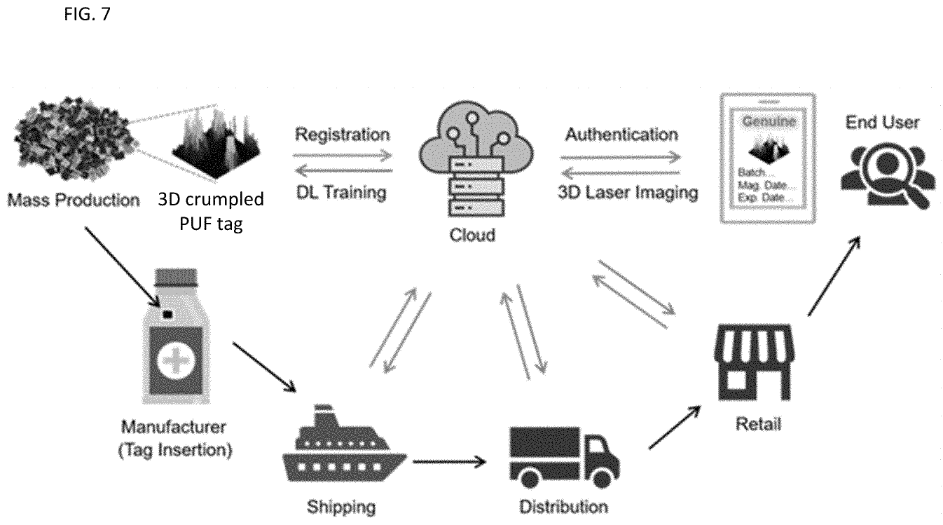

Attributing to the demonstrated controllable as desired size of the 3D crumple PUF tags and their robust pick and authenticate strategy based on the developed DL algorithms, the proposed 3D crumple PUF key-based, anti-counterfeiting technology is expected to enhance supply chain security against counterfeits for high-value products. FIG. 7 schematically illustrates the example of application of a chosen 3D crumple PUF tag in the supply chain. These PUF tags can first be produced by the manufacturers and sold to goods producers for packaging. Thereafter, the 3D cnimple PUF tags are attached to the products (e.g., drugs), comprehensively read (whole area of the pattern) by the 3D laser imaging approach, learned, and stored in the cloud database. During the circulation of the products, the 3D crumple PUF tags will be read (any sub-area), digitized, and authenticated at each stage of the supply chain, including shipping, distribution, retail, and the end-user. If the read 3D crumple PUF key does not match any in the cloud database, then it will be considered fake. As long as the imaging settings (e.g., laser power, resolution) are kept consistent throughout the process, the authentication robustness could be maintained at a very high level with a 0% false-negative authentication rate, enabling the promising implementation of this anti-counterfeiting technology in the industry.

Overall, as a skilled person will now appreciate, the threshold set between fake and authentic cases in implementation of an embodiment is defined based on the upper limit of the image similarity level in the training database. Once the sample image is taken and sent for authentication, the sample will be recognized as “fake” if the similarity level falls above the upper limits, and the sample will be recognized as “authentic” if the similarity level falls below the upper limits.)

Overall, the discussed embodiments illustrated a simple and scalable strategy of fabrication of a 3D-information possessing PUF tag by harnessing the out-of-plane crumpling of an initially substantially planar layer of a 2D material during the underlying substrate shrinkage. The structural details of the resulting so-called 3D crumple PUF pattern are extracted layer by layer using a simple optical imaging methodology (as discussed—a portable laser confocal microscope) and then reconstructed and stored in the database. The distributor/customer can simply read the 3D crumple PUF tag using a portable laser reader, which will be synced, re-constructed, and authenticated using our customized Siamese neural network. This 3D crumple PUF key-based anti-counterfeiting system demonstrates various advantages over conventional 2D PUF patterns in terms of encoding capacity (10^{41,034,867} vs. 10^{144,600}), processing time (1 min vs. up to 40 min), high authentication security, and robustness (even under influences of rotation, x/y/z shift, laser power/contrast/resolution variations, etc.), and low power consumption and fabrication cost. Further, a two-step pick and authenticate strategy was developed to enable high authentication robustness of the 3D crumple PUF anti-counterfeiting, which is free of influences from possible rotation, x/y/z shift, tilt, laser power/contrast/resolution variations, etc. during the practical authentication scenarios, facilitating the unbreakable anti-counterfeiting, for example through an entire manufacturer-distributor-customer distribution process.

The contents of any publications referenced in this disclosure is incorporated by reference herein.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

A person of ordinary skill in the art will readily appreciate that references throughout this specification to “one embodiment,” “an embodiment,” “a related embodiment,” or similar language mean that a particular feature, structure, or characteristic described in connection with the referred to “embodiment” is included in at least one of the discussed embodiments. Thus, appearances of the phrases “in one embodiment”, “in an embodiment”, and similar language throughout this specification may, but do not necessarily, all refer to the same embodiment. Accordingly—as the skilled artisan will readily appreciate—while in this specification the embodiments have been described in a way that enables a clear and concise specification to be written, it is intended that substantially none of the described embodiments can be employed only by itself to the exclusion of other embodiments (to the effect of practically restriction of some embodiments at the expense of other embodiments), and that substantially any of the described embodiments may be variously combined or separated to form different embodiments without parting from the scope intended for protection.

The expression “A and/or B” has a meaning that is “A alone, B alone, or A and B together”.

Disclosed aspects, or portions of these aspects, may be combined in ways not listed above. Accordingly, implementations of the discussed idea should not be viewed as being limited to the disclosed embodiment(s). The recitations of the claims appended to this disclosure are intended to be assessed in light of the disclosure as a whole. Various changes in the details, steps and components that have been described may be made by those skilled in the art while observing the discussed principles.

What is claimed is:

1. A physical unclonable function (PUF) comprising:
a layer of a 2D material having a top surface containing creases, and
a substrate carrying said layer of a 2D material thereon, the substrate facing a bottom surface of said layer of a 2D material.

2. A PUF according to claim 1, devoid of a gap between the substrate and the layer of a 2D material.

3. A PUF according to claim 1, wherein the layer of a 2D material is laminated with a layer of optically transparent material.

4. A PUF according to claim 1, wherein said creases are stochastic creases extending along a normal to a surface of the substrate.

5. A PUF according to claim 4, wherein the surface of the substrate contains a curved surface.

6. A PUF according to claim 1, having an encoding capacity equal to a value resulting from an exponentiation of a base integer raised to the power of an exponent,
wherein the exponent is a number of pixels of an optical image of the PUF to a power of three.

7. A PUF according to claim 1, wherein:
(7a) the substrate includes an elastomeric material configured to undergo shrinkage in a plane of the substrate when exposed to an elevated temperature, and/or
(7b) the 2D material includes at least one of a graphene-based 2D material, a silicate clay, a layered double hydroxide (LDHs), a MXene, a transition metal dichalcogenide (TMD), and a transition metal oxide (TMO).

8. A PUF according to claim 7, wherein said creases are stochastically-distributed creases extending along a normal to a surface of the substrate, and wherein encoding capacity of the PUF exceeds 10^{40,000,000}.

9. A PUF according to claim 1, wherein the substrate includes
(9a) a thermally-responsive shrink layer of material having a glass transition temperature and configured to shrink when exposed to a temperature exceeding said glass transition temperature; and/or
(9b) a pre-stretched elastic layer configured to release at a temperature substantially equal to a room temperature.

10. A method for fabrication of the PUF according to claim 1, the method comprising:
disposing a substantially planar layer of a 2D material on a substantially planar surface of a substrate made of a pre-determined material to form a first stack that includes the substrate carrying said substantially planar layer; and
changing a geometrical characteristic of the substrate to crumple the substantially planar layer to form a second stack containing said substrate and a crumpled layer of the 2D material that has a top surface containing creases.

11. A method according to claim 10, wherein said changing includes forming the second stack in which the creases include creases stochastically distributed along the substrate thereby defining said PUF to have encoding capacity exceeding 1040,000,000.

12. A method according to claim 10, comprising forming the first stack devoid of a first gap between the substantially planar layer of the 2D material and the substantially planar surface of the substrate, and wherein the second stack is substantially devoid of a second gap between the crumpled layer of the 2D material and the substrate.

13. A method according to claim 10, comprising laminating either the substantially planar layer of the 2D material or the crumpled layer of the 2D material with an optically-transparent material.

14. A method according to claim 10,
wherein the substrate includes at least one of: (i) a layer of a thermally responsive material having a glass transition temperature and (ii) a pre-stretched elastic layer; and
wherein said changing includes:
(14a) shrinking the layer of a thermally responsive material by exposing the substrate to an elevated temperature exceeding the glass transition temperature and/or
(14b) releasing the pre-stretched elastic layer at a room temperature.

15. A method according to claim 14, wherein said changing includes forming the crumpled layer of the 2D material in which the creases are distributed stochastically.

16. A method for authentication of the PUF according to claim 1, the method comprising:
generating a first optical image of the top surface containing creases;
storing said image in on a tangible, non-transitory storage medium at a first moment of time;
generating a second optical image of the top surface containing creases at a second moment of time that is subsequent to the first moment of time; and
comparing the second image with the first image with the use of a depthwise-separable convolution network.

17. A method according to claim 16, wherein said comparing includes comparing the second image with the first image to define a dissimilarity matrix.

18. A method according to claim 16, wherein said comparing includes deriving a dissimilarity index with the use of a Siamese neural network

19. A method according to claim 16, wherein a result of said comparing is substantially independent from at least a linear shift and/or a degree of rotation and/or a degree of tilt and/or a level of resolution and/or contrast of an image under investigation as well as independent from a level of optical power with the use of which such image has been acquired (and, as a result of it, from a level of irradiance of the image).

20. A method for authentication of the PUF according to claim 8, the method comprising:
generating a first optical image of the top surface containing creases;
storing said image in on a tangible, non-transitory storage medium at a first moment of time;
generating a second optical image of the top surface containing creases at a second moment of time that is subsequent to the first moment of time; and
comparing the second image with the first image with the use of a depthwise-separable convolution network.
